(19) United States
(12) Patent Application Publication
(10) Pub. No.: US 2025/0106808 A1
(43) Pub. Date: Mar. 27, 2025

(54) Methods To Locate Multiple Access Points Equipped with Sparse Positioning Sensors

(71) Applicant: Cisco Technology, Inc., San Jose, CA (US)

(72) Inventors: David Maluf, Mountain View, CA (US); Peiman Amini, Fremont, CA (US); Jerome Henry, Pittsboro, NC (US); Pradeep K. Kathail, Los Altos, CA (US); Matthew S. MacPherson, San Jose, CA (US); Laurent Alexandre Pierrugues, San Jose, CA (US)

(21) Appl. No.: 18/429,229

(22) Filed: Jan. 31, 2024

Related U.S. Application Data
(60) Provisional application No. 63/584,585, filed on Sep. 22, 2023.

(51) Int. Cl. H04W 64/00; G01S 19/42; H04B 7/06; H04B 17/318; H04W 4/33; H04W 84/12; H04W 88/08

(52) U.S. Cl. CPC H04W 64/003; G01S 19/42; H04B 7/0626; H04B 17/318; H04W 4/33; H04W 84/12; H04W 88/08

(57) ABSTRACT

Described herein are devices, systems, methods, and processes for determining the geo-positions of access points (APs) in a wireless network. The techniques involve utilizing geo-positioning data including global navigation satellite system (GNSS) measurements, wireless local area network (WLAN) signal measurements, air pressure measurements, preexisting knowledge, or any combination thereof. The GNSS measurements may include pseudo range measurements. The WLAN signal measurements can include time of arrival (ToA), channel state information (CSI), and/or received signal strength indicator (RSSI) measurements. The geo-position of each AP is calculated by applying Bayes' theorem to all available geo-positioning data and selecting the geo-position hypothesis with the highest probability. The geo-positions of the APs can be updated when a new measurement is obtained. The techniques can handle diverse AP deployments including heterogeneous APs with varying sensor capabilities.

### PRIORITY

This application claims the benefit of and priority of U.S. Provisional patent application Ser. No. 63/584,585, filed Sep. 22, 2023, the disclosure of which is incorporated by reference herein in its entirety.

### FIELD

The present disclosure relates to wireless communication. More particularly, the present disclosure relates to determining geo-positions of access points (APs) utilizing various sensors and calculations.

### BACKGROUND

With the continuous expansion and increasing complexity of wireless networks, managing and optimizing access point (AP) locations have emerged as significant challenges. In contemporary wireless environments, ensuring higher accuracy of AP locations and the quality of service can be essential for optimal network performance. The positioning of APs has traditionally been addressed in a localized context rather than a global one. As a result, there may be inherent difficulties in achieving a comprehensive, global view of AP locations, particularly in indoor environments. The localized perspective can limit the scope and potential of location-based services and can lead to inefficiencies in the deployment and management of APs.

One of the common techniques utilized to determine the position of an AP is through the use of global navigation satellite system (GNSS) technology (The global positioning system (GPS) and other similar systems are example implementations of the GNSS technology). However, the application of GNSS in indoor environments may often produce significant challenges. The ability of GNSS sensors to sense accurately can typically be disrupted indoors, leading to large error variances. Furthermore, not all APs are equipped with the GNSS technology, resulting in a mixed array of devices with different sensing capabilities.

In addition to the challenges associated with GNSS, various wireless local area network (WLAN) signal measurement features may be utilized to estimate distances between APs. These measures, while effective in certain scenarios, can add another layer of complexity to the task of determining and managing the global positioning of APs. The assortment of models, versions, and types of Wi-Fi chips used in APs may further exacerbates the issue, creating difficulties in achieving uniformity and synchronization across the network.

### SUMMARY OF THE DISCLOSURE

Systems and methods for determining geo-positions of access points (APs) utilizing various sensors and calculations in accordance with embodiments of the disclosure are described herein. In some embodiments, a geolocation logic is configured to receive geo-positioning data associated with a plurality of access points (APs), the geo-positioning data including two or more of 1) one or more global navigation satellite system (GNSS) measurements, 2) one or more wireless local area network (WLAN) signal measurements, 3) one or more air pressure measurements, or 4) preexisting knowledge, and determine a set of geo-positions of a set of APs in the plurality of APs based on the geo-positioning data, each AP in the set of APs corresponding to one geo-position in the set of geo-positions.

In some embodiments, the one or more GNSS measurements include one or more pseudo range measurements.

In some embodiments, the one or more WLAN signal measurements include one or more time of arrival (ToA) measurements.

In some embodiments, the one or more WLAN signal measurements include one or more channel state information (CSI) measurements.

In some embodiments, the one or more WLAN signal measurements include one or more received signal strength indicator (RSSI) measurements.

In some embodiments, at least one WLAN signal measurement in the one or more WLAN signal measurements correlates with a distance between a pair of APs in the plurality of APs.

In some embodiments, at least one air pressure measurement in the one or more air pressure measurements correlates with an elevation of an AP in the plurality of APs.

In some embodiments, the preexisting knowledge includes at least a distance between a pair of APs in the plurality of APs.

In some embodiments, the preexisting knowledge includes at least a geo-position of an AP in the plurality of APs.

In some embodiments, at least one AP in the plurality of APs includes a GNSS receiver.

In some embodiments, at least one AP in the plurality of APs includes an air pressure sensor.

In some embodiments, the plurality of APs are located indoors.

In some embodiments, the plurality of APs is located on more than one floor in a building.

In some embodiments, the geolocation logic is further configured to generate, for each AP in the set of APs, a plurality of geo-position hypotheses, calculate, for each AP in the set of APs, a probability for each geo-position hypothesis in the plurality of geo-position hypotheses, and select, for each AP in the set of APs, a geo-position hypothesis associated with a highest probability as a determined geo-position of the AP.

In some embodiments, the geolocation logic is further configured to transmit an indication of a probability of the at least one geo-position.

In some embodiments, the geolocation logic is further configured to receive an updated geo-positioning data point associated with the plurality of APs, and determine an updated set of geo-positions of the set of APs based on the updated geo-positioning data point.

In some embodiments, the geolocation logic is further configured to transmit an indication of at least one geo-position in the set of geo-positions.

In some embodiments, a geolocation logic is configured to receive geo-positioning data associated with a plurality of access points (APs), the geo-positioning data including two or more of 1) one or more global navigation satellite system measurements, 2) one or more wireless local area network signal measurements, 3) one or more air pressure measurements, or 4) preexisting knowledge, determine a set of geo-positions of a set of APs in the plurality of APs based on the geo-positioning data, each AP in the set of APs corresponding to one geo-position in the set of geo-positions, receive an updated geo-positioning data point associated with the plurality of APs, and determine an updated set of geo-positions of the set of APs based on the updated geo-positioning data point.

In some embodiments, the geolocation logic is further configured to transmit an indication of at least one geo-position in the set of geo-positions.

In some embodiments, a method for geolocating access points (APs) includes receiving geo-positioning data associated with a plurality of APs, the geo-positioning data including two or more of 1) one or more global navigation satellite system measurements, 2) one or more wireless local area network signal measurements, 3) one or more air pressure measurements, or 4) preexisting knowledge, and determining a set of geo-positions of a set of APs in the plurality of APs based on the geo-positioning data, each AP in the set of APs corresponding to one geo-position in the set of geo-positions.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a floorplan with a plurality of network devices in accordance with various embodiments of the disclosure;

FIG. 2 is a diagram illustrating a system environment in accordance with various embodiments of the disclosure;

FIG. 3 is a conceptual illustration of an artificial neural network in accordance with various embodiments of the disclosure;

FIG. 4 is a conceptual illustration of Bayesian framework in accordance with various embodiments of the disclosure;

FIG. 5 is a flowchart showing a Bayesian inference process in accordance with various embodiments of the disclosure;

FIG. 6 is a flowchart showing a process for determining and transmitting the geo-positions of a set of network devices in accordance with various embodiments of the disclosure;

FIG. 7 is a flowchart showing a process for determining and transmitting the geo-positions of a set of network devices in accordance with various embodiments of the disclosure;

FIG. 8 is a flowchart showing a process for determining, updating, and transmitting the geo-positions of a set of network devices in accordance with various embodiments of the disclosure; and

FIG. 9 is a conceptual block diagram for one or more devices capable of executing components and logic for implementing the functionality and embodiments described above;

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can be utilized to accurately determine geo-positions of access points (APs) positions. Hereinafter terms including geo-positioning, geo-localization, localization, geolocating, or geolocation may be used interchangeably. Any of the terms may refer to the process of determining or estimating the geographic position (e.g., geographic/global coordinates including latitude, longitude, and/or altitude) of an object (e.g., a wireless network device such as an AP).

In many embodiments, techniques described herein may be applied in wireless environments with a diverse range of AP models and versions, with the APs equipped with various sensors, such as, but not limited to, GNSS sensors and/or air pressure sensors. In a number of embodiments, the sensors can be modular sensors, which may be removably installed on the APs. In a variety of embodiments, an AP may be equipped to extract measurements from wireless local area network (WLAN) signals (also referred to as Wi-Fi signals hereinafter) received from other APs. In some embodiments, examples of the measurements obtained from WLAN signals can include, but are not limited to, time of arrival (ToA), channel state information (CSI), and/or received signal strength indicator (RSSI). The heterogeneity of the WLAN signal measurements may be associated with the diverse range of AP models and versions, which can be based on a diverse range of Wi-Fi chips, deployed in the wireless environment. In more embodiments, a WLAN signal measurement may be utilized to infer a distance between a pair of APs based on what are known as ranging techniques. In other words, a WLAN signal measurement may correlate with a distance between a pair of APs. In additional embodiments, one or more APs can include air pressure sensors that can provide air pressure measurements. In further embodiments, an air pressure measurement may be utilized to infer an elevation of an AP. In other words, the air pressure measurement can correlate with an elevation of an AP.

In still more embodiments, one or more APs may include GNSS sensors that can be utilized to make GNSS measurements. In still further embodiments, at least some of the APs that include GNSS sensors can be placed near the windows or otherwise have at least a partially clear view to the sky. In still additional embodiments, an AP equipped with a GNSS sensor can make one or more pseudo range measurements to one or more navigation satellites. In some more embodiments, the wireless environment may include APs equipped with GNSS sensors that can observe different sets of navigation satellites. In certain embodiments, preexisting knowledge may be utilized in the determination of geo-positions of APs. By way of non-limiting examples, the preexisting knowledge can include one or more known pairwise AP-to-AP distances or one or more known geo-positions of APs.

In yet more embodiments, the geo-positions of a set of APs in the wireless environment may be determined based on two or more of: 1) GNSS measurements, 2) WLAN signal measurements, 3) air pressure measurements, 4) preexisting knowledge, or 5) any combination thereof. Hereinafter the GNSS measurements, the WLAN signal measurements, the air pressure measurements, and/or the preexisting knowledge can be referred to as, collectively, geo-positioning data. In still yet more embodiments, the geo-position of an AP may be represented by a set of universal coordinates (e.g., geographic/global coordinates including latitude, longitude, and/or altitude). In many further embodiments, to determine the geo-position of an AP, probabilities of multiple geo-position hypotheses for the AP may be calculated. Then, the geo-position hypothesis associated with the highest probability can be selected as the determined geo-position of the AP. In many additional embodiments, the probability of a geo-position hypothesis of an AP given the geo-positioning data may be calculated using Bayes' theorem (also known as Bayes' rule). In still yet further embodiments, the geo-position of an AP can be calculated in sub-spaces, which may be done for reasons such as, but not limited to, mathematical stabilization optimization. In still yet additional embodiments, a state vector including geo-positions of APs and/or distances among the APs can be generated.

In several embodiments, corrections based on the underlying physics models may be factored into the determination of the geo-positions of the APs. In several more embodiments, the corrections can include, but are not limited to, GNSS measurement-related corrections, corrections for indoor signal propagation in relation to WLAN signal measurement-based ranging calculations, or corrections for indoor heating, ventilation, and air conditioning (HVAC) or other systems in relation to air pressure-based elevation estimations. By way of a non-limiting example, when calculating a distance between two APs based on a CSI measurement, magnitude and angle of arrival methods-based corrections for the indoor signal propagation can be utilized.

It may be understood that the application of Bayes' rule may be equivalent to the utilizing of a Kalman filter (KF). Because the nature of the problem may be non-linear, the physics model of the calculations (e.g., trilateration, radio frequency (RF) propagation, etc.) can be non-linear in nature as well. In numerous embodiments, the determination of the geo-positions of the APs may be performed in an iterative manner. In particular, when a new or updated geo-positioning data point becomes available, such as when a new sensor measurement is obtained, the geo-positions of the APs can be updated and refined based on the new/updated geo-positioning data point.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

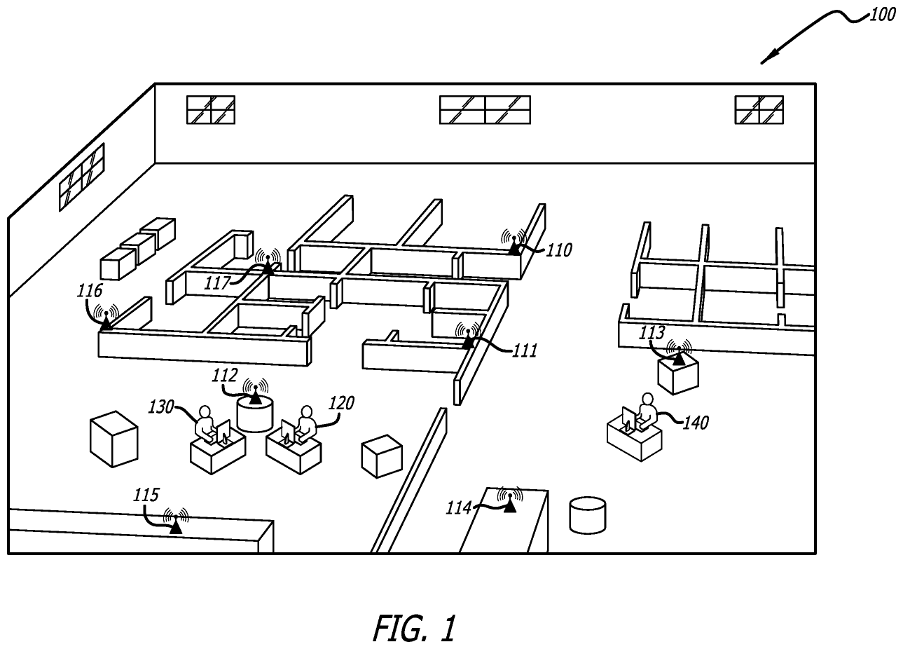

Referring to FIG. 1, a conceptual illustration of a floorplan 100 with a plurality of network devices in accordance with various embodiments of the disclosure is shown. Although the floorplan 100 depicted in the embodiment of FIG. 1 is an office environment, it is contemplated that a floorplan may be any environment that includes a plurality of network devices (e.g., APs) distributed throughout an area. In many embodiments, an area may have multiple floorplans and network devices may be associated with multiple floorplans. By way of a non-limiting example, the network devices may be located on different floors of a building. Indeed, in a number of embodiments, a floorplan may be defined as a collection of network devices and the area that those network devices cover.

In the embodiments depicted in FIG. 1, the floorplan 100 has a first network device 110 at an entranceway to the area. Likewise, a second network device 111 can be placed centrally within the floorplan 100. Within the floorplan 100, three people are depicted working at desk workstations. The first person 120 and second person 130 are working next to a third network device 112. A third person 140 is working next to a fourth network device 113. Additional network devices are distributed throughout the floorplan 100 to provide additional wireless signal coverage including a fifth network device 114, a sixth network device 115, a seventh network device 116, and an eighth network device 117.

The geo-positions of the network devices 110 through 117 can be useful for various applications, such as, but not limited to, indoor navigation, asset tracking, or location-based services. The network devices 110 through 117 may be equipped with GNSS receivers to receive signals from GNSS satellites for geolocation estimation. However, not all network devices may have a clear line-of-sight to the GNSS satellites. In the embodiments depicted in FIG. 1, among the network devices, network devices 110, 116, and 117 may be located closer to the windows 150 and therefore can potentially have a line-of-sight to the GNSS satellites. These network devices 110, 116, and 117 may be able to receive the GNSS satellite signals directly.

On the other hand, the other network devices 111, 112, 113, 114, and 115 may be located further away from the windows 150; accordingly, their line-of-sight to the GNSS satellites may be obstructed by the indoor environment (e.g., by walls or other objects present in the indoor environment). This can lead to issues such as signal attenuation, multipath propagation, or signal blockage, which can degrade the quality of the pseudo range measurements and may even render pseudo range measurements unattainable. In other words, the indoor environment can significantly impact the performance of GNSS-based geolocation estimation, making it difficult to obtain accurate and reliable geo-positions for all network devices.

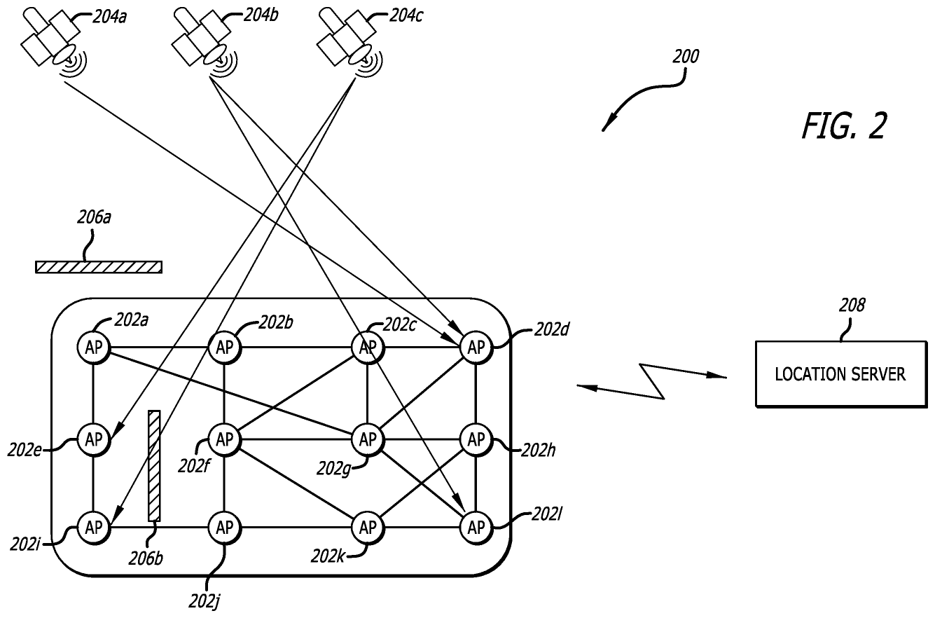

Although a specific embodiment for a floorplan with a plurality of network devices suitable for carrying out the various steps, processes, methods, and operations described herein is discussed with respect to FIG. 1, any of a variety of systems and/or processes may be utilized in accordance with embodiments of the disclosure. For example, the floorplan can include additional features such as walls or partitions of varying materials and thicknesses, which can affect the propagation of signals and thus the accuracy of geolocation estimation. The elements depicted in FIG. 1 may also be interchangeable with other elements of FIGS. 2-9 as required to realize a particularly desired embodiment.

Referring to FIG. 2, a diagram illustrating a system environment 200 in accordance with various embodiments of the disclosure is shown. The embodiments depicted in FIG. 2 show the geolocation estimation process for network devices (e.g., APs) diverse types of geo-positioning data. In many embodiments, the geo-positioning data can include two or more of: 1) GNSS measurements, 2) WLAN signal measurements, 3) air pressure measurements, 4) preexisting knowledge, or 5) any combination thereof. The heterogenous geo-positioning data may be fused together in the geo-localization process. The network devices 202a-1 may be positioned indoors. In a number of embodiments, at least some of the network devices 202a-1 may each be equipped with a GNSS receiver that collects pseudo range data from satellite links at time intervals. By way of a non-limiting example, the network device 202d can make pseudo range measurements to observable GNSS satellites 204a and 204b. In the embodiments shown in FIG. 2, due to the presence of obstacles, just network devices 202e, 202i, 202d, and 2021 may be able to observe GNSS satellites. By way of a non-limiting example, an outdoor obstacle 206a (e.g., a building) can obstruct the network device 202a from observing any GNSS satellites. Each network device collecting pseudo range data can report the respective pseudo range data to the location server 208 (which may correspond to a central unit). In a variety of embodiments, at least one network device may not include a GNSS sensor.

In some embodiments (not shown), the location server 208 may be co-located or implemented at one of the network devices being geo-localized. In more embodiments, the network devices 202a-1 can also collect WLAN signal measurements between each other. By way of a non-limiting example, the network device 202a may measure WLAN signals between itself and each of the network devices 202b, 202g, and 202e. The ability of obtaining WLAN signal measurements can be affected by the distance between network devices and/or by obstacles. By way of a non-limiting example, an indoor obstacle 206b can prevent the measurement of WLANs signals between certain pairs of devices (e.g., between the network device 302e and each of the network devices 202b, 202f, or 202j). In additional embodiments, the relevant network devices can report the WLAN signal measurements to the location server 208. In further embodiments, network devices equipped with air pressure sensors may report air pressure measurements to the location server 208. In still more embodiments, at least one network device may not include an air pressure sensor. In still further embodiments, the location server 208 can receive or otherwise be configured with the preexisting knowledge.

In still additional embodiments, the location server 208 can perform the calculations to determine the geo-positions of the network devices 202a-1 based on two or more of: 1) GNSS measurements, 2) WLAN signal measurements, 3) air pressure measurements, 4) preexisting knowledge, or 5) any combination thereof. In some more embodiments, to determine the geo-position of a network device, probabilities of multiple geo-position hypotheses for the network device may be calculated. Then, the geo-position hypothesis associated with the highest probability can be selected as the determined geo-position of the network device. In certain embodiments, the probability of a geo-position hypothesis of a network device given the geo-positioning data may be calculated using Bayes' theorem. In yet more embodiments, a state vector including geo-positions of network devices and/or distances among the network devices can be generated by the location server 208.

In still yet more embodiments, corrections based on the underlying physics models may be factored into the determination of the geo-positions of the APs. In many further embodiments, the corrections can include, but are not limited to, GNSS measurement-related corrections, corrections for indoor signal propagation (e.g., multipath) in relation to WLAN signal measurement-based ranging calculations, or corrections for indoor HVAC or other systems in relation to air pressure-based elevation estimations. By way of a non-limiting example, when calculating a distance between two APs based on a CSI measurement, magnitude and angle of arrival methods-based corrections for the indoor signal propagation can be utilized.

In many additional embodiments, the determination of the geo-positions of the network devices 302a-1 may be performed in an iterative manner. In particular, when a new or updated geo-positioning data point becomes available, such as when a new sensor measurement is obtained, the geo-positions of the network devices 202a-1 can be updated and refined based on the new/updated geo-positioning data point.

Although a specific embodiment for a system environment suitable for carrying out the various steps, processes, methods, and operations described herein is discussed with respect to FIG. 2, any of a variety of systems and/or processes may be utilized in accordance with embodiments of the disclosure. For example, the network devices can be equipped with advanced GNSS receivers capable of receiving signals from multiple satellite systems simultaneously, thereby increasing the number of observable satellites and enhancing the accuracy of geolocation estimation. The elements depicted in FIG. 2 may also be interchangeable with other elements of FIG. 1 and FIGS. 3-9 as required to realize a particularly desired embodiment.

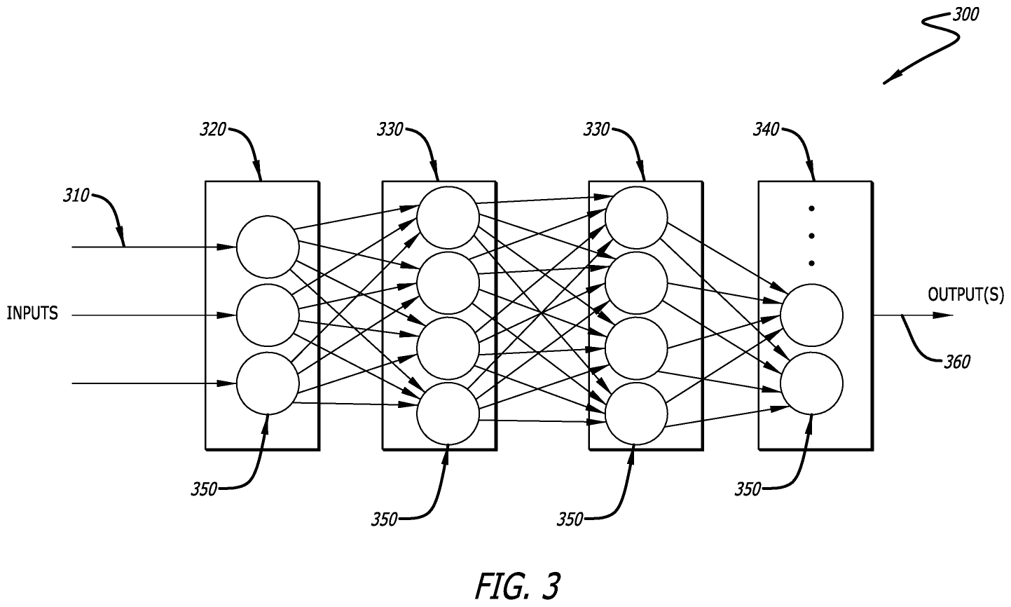

Referring to FIG. 3, a conceptual illustration of an artificial neural network 300 in accordance with various embodiments of the disclosure is shown. As those skilled in the art will recognize, various methods of machine learning models can be utilized to achieve desired outcomes efficiently. For example, some embodiments may utilize decisions trees, random forests, support vector machines, naïve Bayes, or K-nearest neighbor's algorithms. However, artificial neural networks have increased in popularity, especially in deep learning techniques where detection of complex patterns in data and the ability to solve a wide range of problems has been desired. In various embodiments, an artificial neural network may be utilized. Artificial neural networks are a type of machine learning model inspired by the structure and function of the human brain, and often consist of three main types of layers: the input layer, the output layer, and one or more intermediate (also called hidden) layers.

In many embodiments, the input layer is responsible for receiving input data, which could be anything from an image to a text document to numerical values. Each input feature can be represented by a node in the input layer. Conversely, the output layer is often responsible for producing the output of the network, which could be, for example, a prediction or a classification. The number of nodes in the output layer can depend on the task at hand. For example, if the task is to classify images into ten different categories, there would be ten nodes in the output layer, each representing a different category.

The intermediate layers are where the specialized connections are made. These intermediate layers are responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers are learned during training. This training can utilize backpropagation, which may involve calculating the gradient of the error with respect to the weights and adjusting the weights accordingly to minimize the error.

At a high level, the artificial neural network 300 depicted in the embodiment of FIG. 3 includes a number of inputs 310, an input layer 320, one or more intermediate layers 330, and an output layer 340. The artificial neural network 300 may comprise a collection of connected units or nodes called artificial neurons 350, which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 300 depicted in FIG. 3 is shown as an illustrative example, and various embodiments may comprise artificial neural networks that can accept more than one type of input and can provide more than one type of output.

In some embodiments, the signal at a connection between artificial neurons is a value, and the output of each artificial neuron is computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 320) to the last layer (the output layer 340), possibly after traversing one or more intermediate layers (also called hidden layers) 330.

The inputs to an artificial neural network may vary depending on the problem being addressed. In object detection for example, the inputs may be data representing values for certain corresponding actual measurements or values within the object to be detected. In one embodiment, the artificial neural network 300 comprises a series of hidden layers in which each neuron is fully connected to neurons of the next layer. The artificial neural network 300 may utilize an activation function such as sigmoid, nonlinear, or a rectified linear unit (ReLU), upon the sum of the weighted inputs, for example. The last layer in the artificial neural network may implement a regression function to produce the classified or predicted classifications output for object detection as output 360. In further embodiments, a sigmoid function can be used, and the prediction may need raw output transformation into linear and/or nonlinear data.

In many embodiments, the artificial neural network 300 for each model (RSSI, CSI, GPS, etc.) can be empirically trained (given training data sets) in addition and beyond the physics (analytical) to accommodate the real world set ups. Here, physics base analytical models may be ideal models. Such artificial neural network 300 may enhance it by capturing the nuances of the environment. Each artificial neural network 300 may produce in these cases two outputs for each model, viz, 1) is the synthetic data simulation and second a Jacobian equivalent matrix. The inputs in these cases and for each disclosed models can be the estimated parameters calculated through a Bayesian loop.

Although a specific embodiment for an artificial neural network machine learning model suitable for carrying out the various steps, processes, methods, and operations described herein is discussed with respect to FIG. 3, any of a variety of systems and/or processes may be utilized in accordance with embodiments of the disclosure. For example, the artificial neural network may be external operated, such as through a cloud-based service, or a third-party service. The elements depicted in FIG. 3 may also be interchangeable with other elements of FIGS. 1-2 and FIGS. 4-9 as required to realize a particularly desired embodiment.

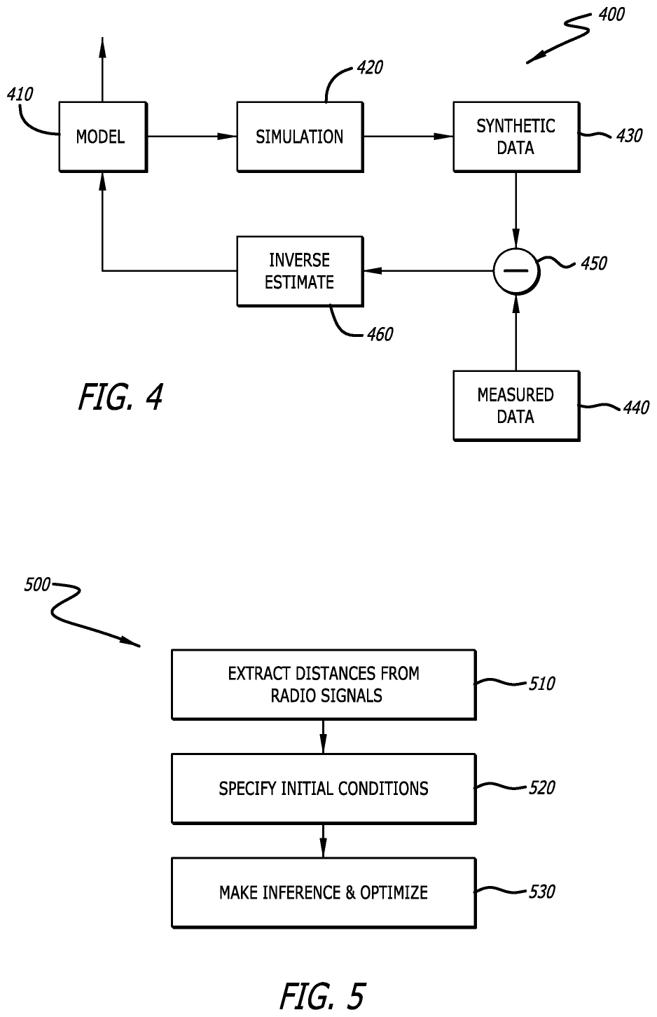

Referring now to FIG. 4, an example Bayesian framework 400 for location tracking, in accordance with various embodiments of the disclosure is shown. In the Bayesian framework 400, a Bayesian inference can be leveraged for location tracking from radio signals collected from APs, GPS sensors, and pressure sensors.

In many embodiments, the Bayesian framework 400 can refer to physics-based models 410 to infer non-linear estimation where physics models 410 are evaluated in a Jacobian form to drive an inference given a prior. The Bayesian framework 400 may utilize models 410 that may differ in their data, structure, assumptions, or mathematical representations, and intrinsic parameters of the models 410 may vary across different scenarios, i.e., the models 410 may be heterogeneous. The physics models 410 may be derived from radio propagation theory where the data is radio signal measurements that include signal strength and angle as well as the wave propagation time measurements, geometry principles such as trilateration, and natural sciences models translating pressure sensors used for elevation. The location tracking objective can be formulated as an inference problem, wherein the Bayesian framework 400 can be exploited to infer the parameters of interest for a given physics model 410. The RSSI, CSI, the Time Base Measurements (TBM) (i.e., the time of flight and time of arrival), the GPS and pressure sensors data may be obtained from wireless APs, on which the inference may be carried out. The data is understood to be sparse and heterogeneous in type and asynchronous in time. Therefore, a non-linear forward physics model 410 of propagation can be employed to differentially infer the location in 3D space, versus time. Consequently, the Bayesian framework 400 can utilize normalized intermediate set of parameters, such as distances, which are non-linear and quadratic in nature, instead of a single global inference.

In a number of embodiments, a simulation 420 may be performed using the prior of the model 410 to generate synthetic data 430. The synthetic data 430 can be generated from the model state estimates via computer simulations of an observation process via the established models 410 of physics in radio propagation and pressure sensor and calibration models for indoor signal adjustments. In the context of target localization, herein, the synthetic data 430 may be generated from the model 410 which may include a parameterized signal strength model, angle of arrival, time of arrival between devices, GPS clocks, or pressure.

In additional embodiments, the synthetic data 430 can compared with the measured data 440, to form an inverse estimate 460. The measured data 440 may include the sparse measurements for RSSI, CSI, GPS, TBM and pressure collected asynchronously from multiple APs. The error 450 between the measured data 440 and the synthetic data 430 can be fed to the simulator 420, through which the system parameters can be accordingly adjusted to minimize the error 450 in the subsequent instances of time. That is, the estimation of the errors 450 may mean the system parameters are updated whenever additional measured data 440 is available.

In further embodiments, the inverse estimate 460 may be utilized to update the model 410, thereby allowing for repeated convergence over time. In an example, the following inverse estimate 460 can be performed—

Given: i^{th} index (from N receivers) and j^{th} index (from M senders), i.e., Receivers and senders could be from the same pool (will create a denser covariance matrix) Scales well due to the sparsity set by Mᵢⱼ, not likely all M senders are observed by N receivers.

The pairwise dielectric in the inverse model estimation may be determined as—

$${E}_{r} = \frac{e * k * {E}_{s}}{{R}^{2}} ; \qquad ( 1 )$$

$${M}_{ij} = \frac{{e}_{ij} * {K}_{i} * {E}_{j}}{{L}_{ij}^{n}} \qquad ( 2 )$$

Where: Eⱼ=Sender gains; Kᵢ=Receiver gains; e=Dielectric constant; eᵢⱼ=paired dielectric parameter

The inverse model estimation can include—

$${E}_{r} = \frac{e * k * {E}_{s}}{{R}^{2}} \to P ( {e}_{ij} , {K}_{i} , {E}_{j} , n - / / {M}_{ij} , {L}_{j} ) \to Min e = / / {M}_{ij} - {\hat{M}}_{ij} / / \qquad ( 3 )$$

Wherein, the Bayesian framework 400 can compute probability of parameters given the measurements. The Bayesian framework 400 can minimize the error. In that, in inverse problem estimation, the model data can be compared to the actual data and correct model parameters to minimize the error.

In many more embodiments, the Hessian matrix can be obtained by—

$$( {J}^{T} J ) x = JT ( m - \hat{m} ) + {\sum }^{- 1} \qquad ( 4 )$$

Where x={eᵢⱼ, Kᵢ, Eⱼ, n} contains the random independent parameter and Σ⁻¹ is the prior on x. J^{T}J is the Hessian matrix.

And J is the Jacobian of the model Mᵢⱼ computed as the differential terms of

$$J = \frac{dM}{dx} \qquad ( 5 )$$

Although a specific embodiment for the Bayesian framework 400 suitable for carrying out the various steps, processes, methods, and operations described herein is discussed with respect to FIG. 4, any of a variety of systems and/or processes may be utilized in accordance with embodiments of the disclosure. For example, the Bayesian framework 400 may be external operated, such as through a cloud-based service, or a third-party service. The elements depicted in FIG. 4 may also be interchangeable with other elements of FIGS. 1-3 and FIGS. 5-9 as required to realize a particularly desired embodiment.

Referring now to FIG. 5, a flowchart showing a Bayesian inference process 500, in accordance with various embodiments of the disclosure is shown.

In many embodiments, the process 500 may extract distances from the radio signals (block 510). Calibration of radio signals between a pair of access points can be to solve for the effective gains αᵢβⱼ, and the APs may be located at a distance Rᵢⱼ from each other, i,j=1, . . . , N. αᵢβⱼ may be per sensor type and not just the devices (i.e., CSI, RSSI and BTM). It can also be assumed that not all access points move at once, and for an infinitesimal period, the localized environment coefficients for a pair as characterized by αᵢβⱼ, may be sensitive to the displacements of the access points. The process 500 can estimate the gains αᵢβⱼ and the distances to each access point Rᵢⱼ, from which the process 500 may directly estimate the location of the APs with trilateration methods. The full vector of distances and access points calibration coefficients can be defined as,

$$u = [ {α}_{i} , {β}_{j} , {R}_{i , j} ] \qquad ( 6 )$$

$$∈ {ℝ}^{N + 1} .$$

To estimate u from the collected measurements, the process 500 may apply Bayes theorem,

$$p ( u \vert {m}_{ij} ) ∝ p ( {m}_{ij} \vert u ) p ( u ) , \qquad ( 7 )$$

Where, mᵢⱼ, i,j=1, . . . , N, can be the measurement of the magnitude of the signal strength for either RSSI, CSI and TBM between the i^{th} and j^{th} devices, where N may denote the total number of devices or access points. Equation (7) states that the posterior of the distances is proportional to the likelihood—the probability of observing the data given the distance and gain coefficients-multiplied by the prior distribution of the distances and coefficients. Furthermore, the prior distribution is assumed to be Gaussian, that is,

$$p ( u ) ∝ exp ( - \frac{1}{2} u {\sum }^{- 1} {u}^{T} ) , \qquad ( 8 )$$

Where the vector u is as defined in (6) and the inverse covariance matrix can be—

$${\sum }^{- 1} = [ \begin{matrix}{χ}_{11} & {χ}_{12} & … & 0 \\ 0 & {χ}_{22} & & 0 \\ … & & … & \\ 0 & 0 & … & {χ}_{NN}\end{matrix} ] , \qquad ( 9 )$$

Which is designed, as in Equation (9), to reflect the prior on the coefficients and distances of each AP. The process 500 may penalize over the difference between the last estimates and the priors, therefore, reflecting the error and controlled by a Gaussian distribution. For each pair of access point, the distances uᵢⱼ,

$${χ}_{ij} = \frac{{η}_{ij}}{\sqrt{2 {πσ}_{ij}^{2}}} {e}^{- ( {u}_{ij} - {u}_{0} ) / 2 {σ}_{ij}^{2}} , \qquad ( 10 )$$

where i,j denote two antennas' indices on any access point APᵢⱼ, ij=1, 2, . . . , N. and σᵢⱼ are two arbitrary sensitivity factors reflecting the arbitrary control on the prior. It is with a choice of ηᵢⱼ and σᵢⱼ that anchoring devices data points are selected. Practically, on time zero, αᵢ, βⱼ can be inferred when a selection of Rᵢⱼ are initialized and defined. This method of adapting the prior to meet boundary conditions in Bayesian sense. For optimization methods, this can allow a global minimum to be reached.

For the likelihood derivations, the process 500 can make the following assumptions: (1) The difference between the measured real data and the synthesized observed data follows a zero mean Gaussian distribution, (2) The measurements are conditionally independent, which yields,

$$p ( {m}_{ij} , ... , {m}_{NN} \vert u ) ∝ exp ( - \frac{{\sum }_{i} {\sum }_{j} {( {m}_{ij} - {\hat{m}}_{ij} ( u ) )}^{2}}{2 {σ}_{e}^{2}} ) , \qquad ( 11 )$$

Where, \hat{m}ᵢⱼ(u) denotes calculated measurements of the signal strength on the i^{th} AP, and σₑ² is the noise variance. Therefore, the negative-log posterior is written as,

$$ℒ ( u ) ∝ exp ( - \frac{{\sum }_{i} {\sum }_{j} {( {m}_{ij} - {\hat{m}}_{ij} ( u ) )}^{2}}{2 {σ}_{e}^{2}} ) + u {\sum }^{- 1} {u}^{T} \qquad ( 12 )$$

As can be clearly seen, Equation (11) is a nonlinear function of u and the maximum a posteriori (MAP) estimate is that value of u which minimizes [symbol] (u). Gradient methods can be applied to minimize negative log-posterior L(u) [20,21,27]. The vector of synthesized magnitudes of the distances and calibration coefficients is denoted by \hat{m}(u), which is linearized about the current estimate u₀, that is,

$$\hat{m} ( u ) = \hat{m} ( {u}_{0} ) + D ( u - {u}_{0} ) , \qquad ( 13 )$$

Where, D∈ [symbol] ^{N×N+1} is the matrix of derivatives evaluated at u₀. The i-th row of with D is evaluated as follows:

$$D = [ \frac{\partial {\hat{m}}_{ij}}{\partial {R}_{ij}} , \frac{\partial {\hat{m}}_{ij}}{\partial {α}_{i}} , \frac{\partial {\hat{m}}_{ij}}{\partial {β}_{j}} ] , i , j = 1 , ... N . \qquad ( 14 )$$

D is also known as the Jacobian J steering matrix. Therefore, the minimization of [symbol] (u) can be replaced with the minimization of the following quadratic form—

$${ℒ}^{′} = \frac{1}{2} x \hat{A} {x}^{T} - bx , x = u - {u}_{0} , \qquad ( 15 )$$

$${ℒ}^{′} = \frac{1}{2} x \hat{A} {x}^{T} - bx , x = u - {u}_{0} , \qquad ( 16 )$$

$$A = {\sum }^{- 1} + \frac{{DD}^{T}}{{σ}_{e}^{2}} ; and \qquad ( 17 )$$

$$b = D \frac{( m ( u ) - \hat{m} ( u ) )}{{σ}_{e}^{2}} + {\sum }^{- 1} {u}_{0} , \qquad ( 18 )$$

Where m(u) may be the vector of all measurement values. Here, A may be the Hessian matrix of the quadratic form and the vector b is a gradient of a likelihood, [symbol] ′ computed at current estimate. The process 500 can search for the minimum in x using Levenberg Marquardt methods. At the minimum, the process 500 may update the current estimate, u₁=u₀+x, recompute \hat{m}(u) and D, and repeat the minimization procedure iteratively until the current estimate uₖ converges. Therefore, finding the MAP estimate requires calculating the signal strength magnitude from the model and compute the derivatives for any values of the model parameters.

After estimating vector u, the entries represent the estimate of the calibration coefficients as well, while the first N entries of the vector u represent the estimated distances to each access point as well as the calibration coefficients.

In a number of embodiments, the process 500 may specify initial conditions (block 520). The locations derived from pressure are elevation estimates given Earth Centred, Earth Fixed (ECEF) reference. The receiver is on an ECEF frame of reference at position v, while the k^{th} satellite is at position p^{k}. Then r^{k}=∥p^{k}−v∥ and ρₖ=∥p^{k}−v∥+b+ε^{k}, where b=cdtⱼ represents the receiver clock bias in units of distance. The resolution of the receiver location consists in finding the values of v and b that minimize the differences between the measured and estimated pseudo ranges to each detected satellite. Thus, using \hat{v}ⱼₖ as the unit vector from the receiver to the satellite k, the process 500 can find dv and db such that the true receiver position v=v₀+dv and the true clock bias b=b₀+db minimize:

$$d {ρ}^{k} = {ρ}^{k} - {ρ}_{0}^{k} = [ - {\hat{v}}_{jk} 1 ] [ \begin{matrix}dv \\ db\end{matrix} ] + {ε}^{k} \qquad ( 19 )$$

Using the Taylor series expansion of the vector norm to express the delta pseudo range as a matrix multiplication between known and unknown quantities. The solution is found iteratively, for each satellite, then for the set of the detected K satellites. Setting

$$A = [ \begin{matrix}- {\hat{x}}_{j 1} & 1 \\ - {\hat{x}}_{j 2} & 1 \\ ... & ... \\ - {\hat{x}}_{jk} & 1\end{matrix} ] ,$$

the iterative process solves:

$$d ρ = A [ \begin{matrix}dv \\ db\end{matrix} ] + ε \qquad ( 20 )$$

A least square solution is used to solve the system, where:

$$[ \begin{matrix}\hat{v} \\ \hat{b}\end{matrix} ] = {( {\sum }^{- 1} + {A}^{T} A )}^{- 1} ( {A}^{T} d ρ ) + {\sum }^{- 1} {v}_{0} \qquad ( 21 )$$

Where v₀ may contain the elevation from pressure sensors added to v estimate in the Kalman sense. The initial condition vector v₀ may be sparse in xyz given how many AP equipped were equipped with GPS and sparse in z coordinates given the pressure sensors distribution. Both GPS and Pressure can present an absolute location from an indisputable point of reference and therefore their initial conditions influence may depend on the covariance matrix from the Kalman filter. There inverse covariance could be injected back in the final location estimation.

In various embodiments, the process 500 can iteratively update the parameter vector u in order to minimize the discrepancy between observed measurements and model predictions (block 530). Notwithstanding the extraction of parameters in terms of distances and ranges from radio signals and GPS from the previous sections, the ranges ρⱼ^{k} and Rᵢⱼ are sparse. In fact, the matrix ρⱼ^{k} is expected to be extremely sparse. Therefore, the success inference depends on how stable the Hessian matrix. A stability test will determine the effect of sparsity on the results. Alternatively, inference can occur in the subspaces where the measurements are minimally sufficient.

The global locations may be estimated by solving the following set of N quadratic trilateration equations,

$$[ \begin{matrix}{R}_{ij} \\ {ρ}_{j}^{k}\end{matrix} ] = [ \begin{matrix}‖ v - {v}_{i} ‖ \\ ‖ v - {v}_{k} ‖\end{matrix} ] , i , j , k = 1 , ... , N . \qquad ( 22 )$$

Where the full vector of locations can be defined as,

$$v = [ {x}_{i} , {y}_{i} , {z}_{i} ] ∈ {ℝ}^{N + 1} . \qquad ( 23 )$$

Using Bayes theorem for final time,

$$p ( x , y , z \vert v ) ∝ p ( v \vert x , y , z ) p ( x , y , z ) , \qquad ( 24 )$$

Where (x, y, z) is an absolute location coordinate. Here, the prior is assumed to be of Gaussian distribution. From equations (10), (11), (12) and (13) a new matrix of derivatives D∈ [symbol] ^{N×N+1} evaluated at v₀. The i-th and j-th row of D is evaluated as follows:

$$D = [ \frac{\partial {\hat{R}}_{ij}}{\partial {x}_{i}} , \frac{\partial {\hat{R}}_{ij}}{\partial {y}_{i}} , \frac{\partial {\hat{R}}_{ij}}{\partial {z}_{i}} , \frac{\partial {\hat{ρ}}_{j}^{k}}{\partial {x}_{j}} , \frac{\partial {\hat{ρ}}_{j}^{k}}{\partial {y}_{j}} , \frac{\partial {\hat{ρ}}_{j}^{k}}{\partial {z}_{j}} ] \qquad ( 25 )$$

$$i , j = 1 , ... N . \qquad ( 26 )$$

$$x = v - {v}_{0} , \qquad ( 27 )$$

$$A = {\sum }^{- 1} + \frac{{DD}^{T}}{{σ}_{e}^{2}} ; and \qquad ( 28 )$$

$$b = D \frac{( m ( u ) - \hat{m} ( u ) )}{{σ}_{e}^{2}} + {\sum }^{- 1} {v}_{0} , \qquad ( 29 )$$

Where m(u) is the vector of all distances and pseudo-ranges measurement values. Here, A is the Hessian matrix of the quadratic form and the vector b is a gradient of a likelihood computed at current estimate. The process 500 can search for the minimum in x using Levenberg Marquardt methods. At the minimum, the process 500 may update the current estimate, v₁=v₀+x, recompute \hat{m}(u) and D, and repeat the minimization procedure iteratively until the current estimate uₖ converges.

$$\begin{matrix}Control & Radio Propagation \\ Prior Matrix & Models \\ & Wi - Fi , GPS \\ ↓ & ↓ \\ A = {\sum }^{- 1} + & \frac{{DD}^{T}}{{σ}_{e}^{2}} ; b =\end{matrix} \begin{matrix}Wi - Fi Distances & GPS Location \\ GPS Pseudo - range & Pressure Elevation \\ Measurements & Measurements \\ ↓ & ↓ \\ D \frac{( m ( u ) - \hat{m} ( u ) )}{{σ}_{e}^{2}} & + {\sum }^{- 1} {v}_{0}\end{matrix} \qquad ( 30 )$$

Although a specific embodiment for Bayesian inference process 500 for carrying out the various steps, processes, methods, and operations described herein is discussed with respect to FIG. 5, any of a variety of systems and/or processes may be utilized in accordance with embodiments of the disclosure. For example, the Bayesian inference process 500 may easily scale for any given number of APs. The elements depicted in FIG. 5 may also be interchangeable with other elements of FIGS. 1-4 and FIGS. 6-9 as required to realize a particularly desired embodiment.

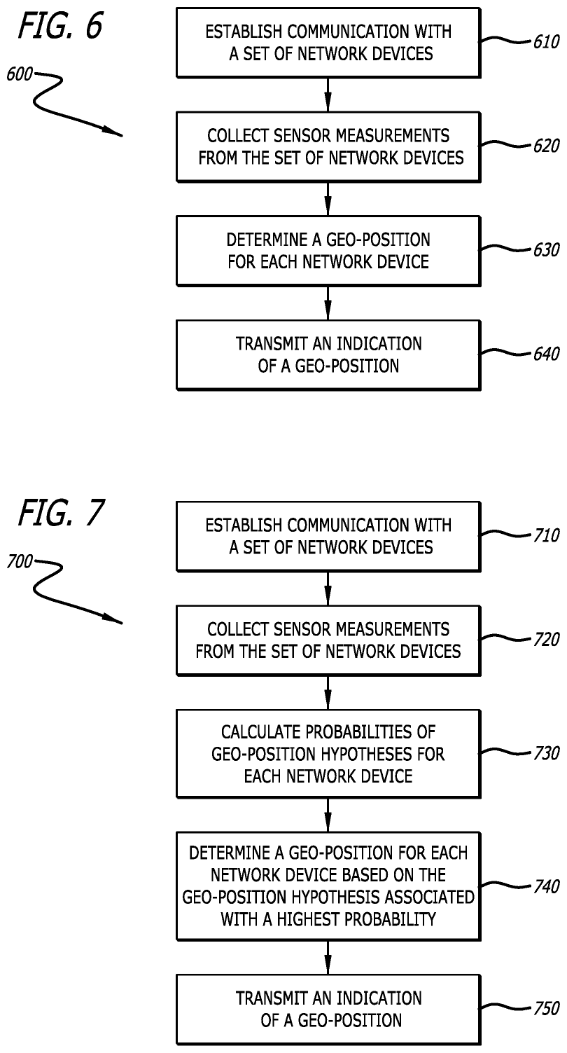

Referring to FIG. 6, a flowchart showing a process 600 for determining and transmitting the geo-positions of a set of network devices in accordance with various embodiments of the disclosure is shown. In many embodiments, the process 600 may establish communication with a set of network devices (block 610). In a number of embodiments, establishing the communication can involve initiating a connection with each network device in the set, or accepting incoming connection requests from the network devices. In a variety of embodiments, the network devices may be APs in a wireless network, and the communication can be established over wireless or wired connections.

In some embodiments, the process 600 can collect sensor measurements from the set of network devices (block 620). In more embodiments, the sensor measurements may include data from various types of sensors present on the network devices, such as, but not limited to, GNSS sensors, WLAN signal receivers/sensors, and/or air pressure sensors. In additional embodiments, GNSS measurements from GNSS sensors may include pseudo range measurements. In further embodiments, WLAN signal measurements can include measurements such as, but not limited to, ToA, CSI, and/or RSSI measurements.

In still more embodiments, the process 600 may determine a geo-position for each network device (block 630). In still further embodiments, to determine a geo-position for a network device, Bayes' theorem can be applied to the geo-positioning data (which can include sensor measurements, preexisting knowledge, or any combination thereof) to calculate probabilities of multiple geo-position hypotheses. In other words, multiple geo-position hypotheses may be generated for the network device. Then, a probability can be calculated for each geo-position hypothesis of the multiple geo-position hypotheses based on Bayes' theorem. Thereafter, the geo-position hypothesis with the highest probability may be selected as the determined geo-position. In still additional embodiments, the geo-position of each network device may be represented as a set of coordinates in a global or universal coordinate system.

In some more embodiments, the process 600 can transmit an indication of a geo-position (block 640). In certain embodiments, transmitting the indication of the geo-position may involve sending a message or data packet over the network that includes the determined geo-position of a network device. In yet more embodiments, the indication of the geo-position can be sent to a central server or the respective network device for further processing or use in network operations.

Although a specific embodiment for determining and transmitting the geo-positions of a set of network devices suitable for carrying out the various steps, processes, methods, and operations described herein is discussed with respect to FIG. 6, any of a variety of systems and/or processes may be utilized in accordance with embodiments of the disclosure. For example, the determination of the geo-positions may be carried out at a network controller device that is responsible for managing the set of network devices. The elements depicted in FIG. 6 may also be interchangeable with other elements of FIGS. 1-5 and FIGS. 7-9 as required to realize a particularly desired embodiment.

Referring to FIG. 7, a flowchart showing a process 700 for determining and transmitting the geo-positions of a set of network devices in accordance with various embodiments of the disclosure is shown. In many embodiments, the process 700 may establish communication with a set of network devices (block 710). In a number of embodiments, establishing the communication can involve initiating a connection with each network device in the set, or accepting incoming connection requests from the network devices. In a variety of embodiments, the network devices may be APs in a wireless network, and the communication can be established over wireless or wired connections.

In some embodiments, the process 700 can collect sensor measurements from the set of network devices (block 720). In more embodiments, the sensor measurements may include data from various types of sensors present on the network devices, such as, but not limited to, GNSS sensors, WLAN signal receivers/sensors, and/or air pressure sensors. In additional embodiments, GNSS measurements from GNSS sensors may include pseudo range measurements. In further embodiments, WLAN signal measurements can include measurements such as, but not limited to, ToA, CSI, and/or RSSI measurements.

In still more embodiments, the process 700 may calculate probabilities of geo-position hypotheses for each network device (block 730). Multiple geo-position hypotheses may be generated for the network device before the probabilities are calculated. In still further embodiments, calculating the probabilities of geo-position hypotheses can involve applying a statistical method, such as Bayes' theorem, to the collected sensor measurements, preexisting knowledge, or any combination thereof. Each geo-position hypothesis may represent a possible location of a network device, and the calculated probability can indicate the likelihood that the network device is at that location.

In still additional embodiments, the process 700 can determine a geo-position for each network device based on the geo-position hypothesis associated with a highest probability (block 740). In some more embodiments, determining the geo-position may involve selecting the geo-position hypothesis with the highest calculated probability as the determined geo-position for the network device. In certain embodiments, the determined geo-position can be represented as a set of coordinates in a global or universal coordinate system.

In yet more embodiments, the process 700 may transmit an indication of a geo-position (block 750). In still yet more embodiments, transmitting the indication of the geo-position may involve sending a message or data packet over the network that includes the determined geo-position of a network device. In many further embodiments, the indication of the geo-position can be sent to a central server or the respective network device for further processing or use in network operations.

Although a specific embodiment for determining and transmitting the geo-positions of a set of network devices for carrying out the various steps, processes, methods, and operations described herein is discussed with respect to FIG. 7, any of a variety of systems and/or processes may be utilized in accordance with embodiments of the disclosure. For example, the determination of the geo-positions of network devices can be carried out on a cloud-based network management platform that collects sensor measurements from network devices distributed across multiple geographical locations. The elements depicted in FIG. 7 may also be interchangeable with other elements of FIGS. 1-6, and FIGS. 8-9 as required to realize a particularly desired embodiment.

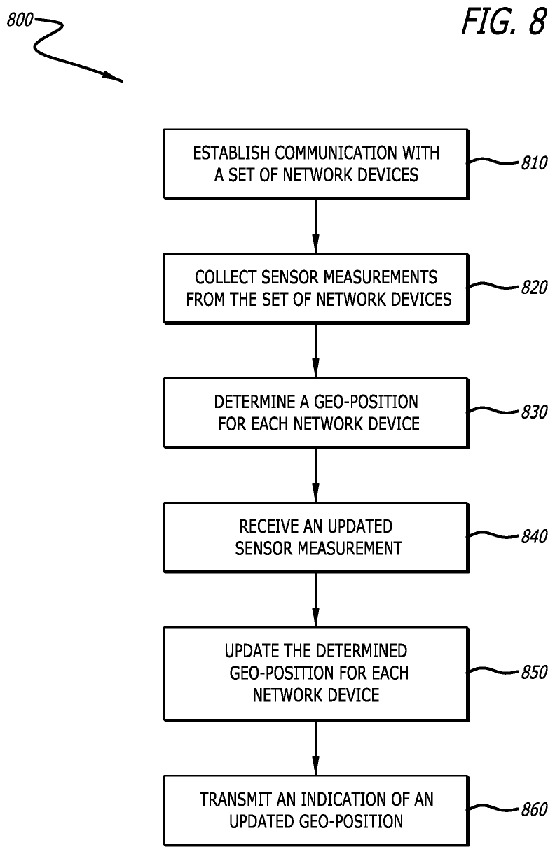

Referring to FIG. 8, a flowchart showing a process 800 for determining, updating, and transmitting the geo-positions of a set of network devices in accordance with various embodiments of the disclosure is shown. In many embodiments, the process 800 may establish communication with a set of network devices (block 810). In a number of embodiments, establishing the communication can involve initiating a connection with each network device in the set, or accepting incoming connection requests from the network devices. In a variety of embodiments, the network devices may be APs in a wireless network, and the communication can be established over wireless or wired connections.

In some embodiments, the process 800 can collect sensor measurements from the set of network devices (block 820). In more embodiments, the sensor measurements may include data from various types of sensors present on the network devices, such as, but not limited to, GNSS sensors, WLAN signal receivers/sensors, and/or air pressure sensors. In additional embodiments, GNSS measurements from GNSS sensors may include pseudo range measurements. In further embodiments, WLAN signal measurements can include measurements such as, but not limited to, ToA, CSI, and/or RSSI measurements.

In still more embodiments, the process 800 may determine a geo-position for each network device (block 830). In still further embodiments, to determine a geo-position for a network device, Bayes' theorem can be applied to the geo-positioning data (which can include sensor measurements, preexisting knowledge, or any combination thereof) to calculate probabilities of multiple geo-position hypotheses. In other words, multiple geo-position hypotheses may be generated for the network device. Then, a probability can be calculated for each geo-position hypothesis of the multiple geo-position hypotheses based on Bayes' theorem. Thereafter, the geo-position hypothesis with the highest probability may be selected as the determined geo-position. In still additional embodiments, the geo-position of each network device may be represented as a set of coordinates in a global or universal coordinate system.

In some more embodiments, the process 800 can receive an updated sensor measurement (block 840). In certain embodiments, receiving the updated sensor measurement may involve receiving new data from the sensors on the network devices. In yet more embodiments, the updated sensor measurement can reflect changes in the environment or the network devices.

In still yet more embodiments, the process 800 may update the determined geo-position for each network device (block 850). In many further embodiments, updating the determined geo-position can involve recalculating the geo-position of each network device based on the updated sensor measurement. In many additional embodiments, the updated geo-position may reflect the updated or refined location of each network device.

In still yet further embodiments, the process 800 can transmit an indication of an updated geo-position (block 860). In still yet additional embodiments, transmitting the indication of the updated geo-position may involve sending a message or data packet over the network that includes the updated geo-position of a network device. In several embodiments, the indication of the updated geo-position can be sent to a central server or the respective network device for further processing or use in network operations.

Although a specific embodiment for determining, updating, and transmitting the geo-positions of a set of network devices for carrying out the various steps, processes, methods, and operations described herein is discussed with respect to FIG. 8, any of a variety of systems and/or processes may be utilized in accordance with embodiments of the disclosure. For example, the geo-positions of the network devices can be continuously updated based on real-time sensor measurements. The elements depicted in FIG. 8 may also be interchangeable with other elements of FIGS. 1-7 and FIG. 9 as required to realize a particularly desired embodiment.

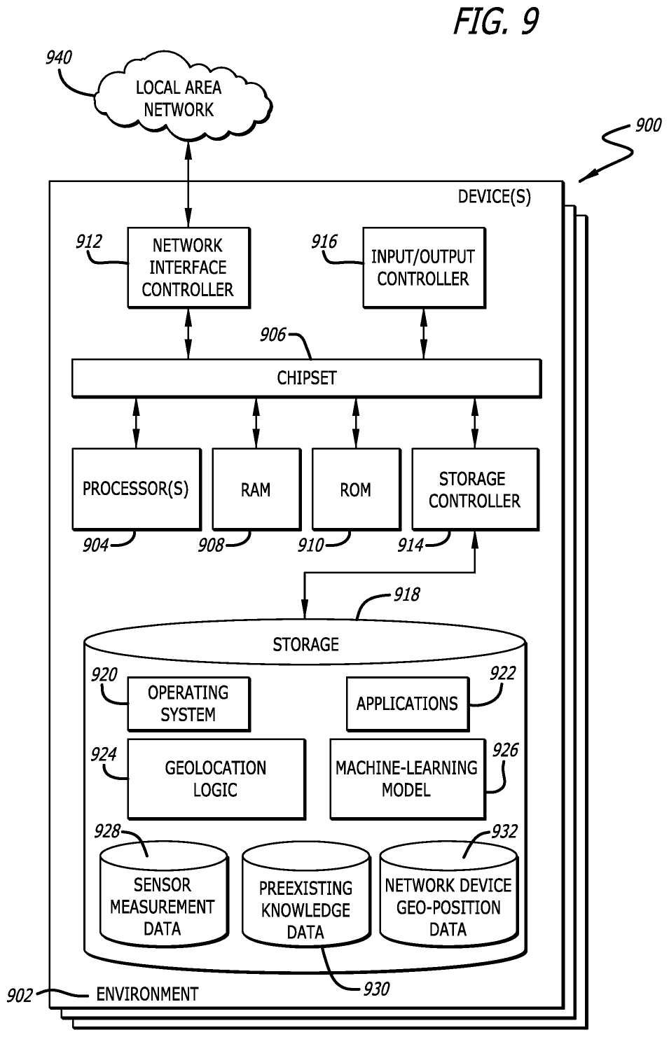

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, sensor measurement data 928, preexisting knowledge data 930, and network device geo-position data 932, which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiment, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many embodiments, the device 900 can include a geolocation logic 924. The geolocation logic 924 may be configured to determine the geo-positions of a set of network devices based on collected sensor measurements and/or preexisting knowledge and a statistical method. The geolocation logic 924 can utilize a variety of data, such as GNSS measurements, WLAN signal measurements, air pressure measurements, preexisting knowledge, or any combination thereof, to calculate the geo-positions of the network devices.

In a number of embodiments, the storage 918 can include sensor measurement data 928. The sensor measurement data 928 may include various types of measurements collected from sensors present on a set of network devices. The sensor measurement data 928 can be utilized by the geolocation logic to determine the geo-positions of the network devices, and may include data from GNSS sensors, WLAN signal receivers/sensors, and/or air pressure sensors.

In various embodiments, the storage 918 can include preexisting knowledge data 930. The preexisting knowledge data 930 may include, by way of non-limiting examples, previous locations of some network devices or known distances between certain network devices. The preexisting knowledge data 930 can be utilized by the geolocation logic in conjunction with sensor measurements to determine the geo-positions of the network devices.

In still more embodiments, the storage 918 can include network device geo-position data 932. The network device geo-position data 932 may represent the determined geo-positions of a set of network devices, as calculated by the geolocation logic. The network device geo-position data 932 can be updated as new sensor measurements and preexisting knowledge data are received.

Finally, in many embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to analyze the sensor measurement data and the preexisting knowledge data to predict the geo-positions of the network devices, and to continuously learn and improve its predictions over time as more data is collected.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor, wherein the memory comprises a geolocation logic that is configured to:
receive geo-positioning data associated with a plurality of access points (APs), the geo-positioning data comprising two or more of: 1) one or more global navigation satellite system (GNSS) measurements, 2) one or more wireless local area network (WLAN) signal measurements, 3) one or more air pressure measurements, or 4) preexisting knowledge; and
determine a set of geo-positions of a set of APs in the plurality of APs based on the geo-positioning data, each AP in the set of APs corresponding to one geo-position in the set of geo-positions.

2. The network device of claim 1, wherein the one or more GNSS measurements include one or more pseudo range measurements.

3. The network device of claim 1, wherein the one or more WLAN signal measurements include one or more time of arrival (ToA) measurements.

4. The network device of claim 1, wherein the one or more WLAN signal measurements include one or more channel state information (CSI) measurements.

5. The network device of claim 1, wherein the one or more WLAN signal measurements include one or more received signal strength indicator (RSSI) measurements.

6. The network device of claim 1, wherein at least one WLAN signal measurement in the one or more WLAN signal measurements correlates with a distance between a pair of APs in the plurality of APs.

7. The network device of claim 1, wherein at least one air pressure measurement in the one or more air pressure measurements correlates with an elevation of an AP in the plurality of APs.

8. The network device of claim 1, wherein the preexisting knowledge includes at least a distance between a pair of APs in the plurality of APs.

9. The network device of claim 1, wherein the preexisting knowledge includes at least a geo-position of an AP in the plurality of APs.

10. The network device of claim 1, wherein at least one AP in the plurality of APs includes a GNSS receiver.

11. The network device of claim 1, wherein at least one AP in the plurality of APs includes an air pressure sensor.

12. The network device of claim 1, wherein the plurality of APs are located indoors.

13. The network device of claim 12, wherein the plurality of APs is located on more than one floor in a building.

14. The network device of claim 1, wherein to determine the set of geo-positions of the set of APs, the geolocation logic is further configured to:
generate, for each AP in the set of APs, a plurality of geo-position hypotheses;
calculate, for each AP in the set of APs, a probability for each geo-position hypothesis in the plurality of geo-position hypotheses; and
select, for each AP in the set of APs, a geo-position hypothesis associated with a highest probability as a determined geo-position of the AP.

15. The network device of claim 1, wherein the geolocation logic is further configured to transmit an indication of a probability of the at least one geo-position.

16. The network device of claim 1, wherein the geolocation logic is further configured to:
receive an updated geo-positioning data point associated with the plurality of APs; and
determine an updated set of geo-positions of the set of APs based on the updated geo-positioning data point.

17. The network device of claim 1, wherein the geolocation logic is further configured to transmit an indication of at least one geo-position in the set of geo-positions.

18. A network device, comprising:
a processor;
at least one network interface controller configured to provide access to a network; and
a memory communicatively coupled to the processor, wherein the memory comprises a geolocation logic that is configured to:
receive geo-positioning data associated with a plurality of access points (APs), the geo-positioning data comprising two or more of: 1) one or more global navigation satellite system measurements, 2) one or more wireless local area network signal measurements, 3) one or more air pressure measurements, or 4) preexisting knowledge;
determine a set of geo-positions of a set of APs in the plurality of APs based on the geo-positioning data, each AP in the set of APs corresponding to one geo-position in the set of geo-positions;
receive an updated geo-positioning data point associated with the plurality of APs; and
determine an updated set of geo-positions of the set of APs based on the updated geo-positioning data point.

19. The network device of claim 18, wherein the geolocation logic is further configured to transmit an indication of at least one geo-position in the set of geo-positions.

20. A method for geolocating access points (APs), comprising:
receiving geo-positioning data associated with a plurality of APs, the geo-positioning data comprising two or more of: 1) one or more global navigation satellite system measurements, 2) one or more wireless local area network signal measurements, 3) one or more air pressure measurements, or 4) preexisting knowledge; and
determining a set of geo-positions of a set of APs in the plurality of APs based on the geo-positioning data, each AP in the set of APs corresponding to one geo-position in the set of geo-positions.
